(19) United States
(12) Patent Application Publication
(10) Pub. No.: US 2018/0300303 A1
(43) Pub. Date: Oct. 18, 2018

(54) System and Method for Collecting and Automatically Populating Forms between a Client and a Legal Professional

(71) Applicant: Tommy Songfong Wang, City of Industry, CA (US)

(72) Inventor: Tommy Songfong Wang, City of Industry, CA (US)

(21) Appl. No.: 15/488,331

(22) Filed: Apr. 14, 2017

(51) Int. Cl. G06F 17/24; G06Q 50/18

(52) U.S. Cl. CPC G06F 17/243; G06Q 50/18; G06Q 50/184

(57) ABSTRACT

A system and method for collecting and automatically populating forms between a client and a legal professional enables a client to efficiently access a legal disclosure form that is editable and adapted to legal matters. The legal disclosure form may be pertinent to immigration or intellectual property law. The client, through mobile communication device, populates the legal disclosure form with personal information, legal information, and legally pertinent files. The client transmits the populated legal disclosure form to a remote data storage unit through the mobile communication device. A legal professional has access to the remote data storage unit. An algorithm matches the legal disclosure form with an aggregated from. The algorithm populates the aggregate form with the same information as the legal disclosure form, but in a clearer format. The legal professional receives the aggregated form in a format that is easily reviewed and filed with a legal entity.

### FIELD OF THE INVENTION

The present invention relates generally to a system and method for collecting and automatically populating forms between a client and a legal professional. More so, the present invention relates to a system and method that allows a client to securely and efficiently access a legal disclosure form that is editable and adapted to legal matters; whereby the client populates the legal disclosure form with personal information, legal information, and at least one legally pertinent file; whereby the client securely transmits the form to a remote data storage unit through a mobile communication device; whereby a legal professional accesses the populated legal disclosure form; whereby the legal disclosure form creates a relationship with at least one filing form, such that the personal information, legal information, and at least one legally pertinent file collected from the legal disclosure form is transformed into aggregate data that automatically populates the at least one aggregated form; whereby the legal professional receives the at least one aggregated form in a format that can be easily reviewed and filed with a legal entity.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a potential legal client who requires legal assistance must contact and disclose information to an attorney. The attorney must process this information to determine the optimal legal route for the client. Often, clients are frustrated by an inability to easily communicate with their attorney and by their lack of legal knowledge and information regarding the type of case for which they seek legal representation. From the attorney perspective, the client-attorney communication often requires significant administrative overhead on the part of the attorney and legal staff. It is known in the legal field that coordinating meetings, collating documents, and disseminating information takes considerable time and resources.

It is known that for a potential client to contact an attorney, the client often turns to the internet. This can, however become a cumbersome process as the potential client generally does not know an attorney, and thus must go online to guess appropriate Google terms and geographical options. Often, the potential client can simply go to the website of the attorney and email a request for assistance. The client may also call the office of the attorney. The client may also walk directly into an attorney's office. In any case, the legally pertinent information can be difficult to transfer to the attorney; especially for a client that is not familiar with legal methods.

In many instances, an application software (app) allows a potential client to search for legal professionals within a particular area of law or within a particular geographical location. In these methods, it is up to the potential client to make the initial contact with a potential legal professional based on the results of the search. It is also possible that the app could prompt the client to fill out basic information relating to their particular legal matter, and that information is forwarded to a legal professional for review. The legal professional must then follow up with the potential client to discuss potentially going forward with the matter.

Other proposals have involved methods for streamlining the communications between client and attorney. The problem with these systems and methods is that they do not provide the potential client with a convenient legal disclosure form and application that can be viewed and filled out from the client's phone. Also, the legal disclosure form that the client submits is often having poor penmanship, and not in a format conducive for court filings. Even though the above cited gripping methods meet some of the needs of the market, a system and method for collecting and automatically populating forms between a client and a legal professional that allows a client to securely and efficiently access a legal disclosure form that is editable and adapted to legal matters, and then transmit the form to an attorney that can be easily reviewed and filed with a legal entity is still desired.

### SUMMARY

Illustrative embodiments of the disclosure are generally directed to a system and method for collecting and automatically populating forms between a client and a legal professional. The system and method creates efficient interaction between a client and a legal professional, by allowing the client to populate and transmit a legal disclosure form through a mobile communication device, and allowing the legal professional to access the legal disclosure form and automatically populate a filing form having the same information, but in a format that is more easily reviewed and fillable with a legal entity. In this manner, filling out the legal disclosure form is easier for the client, and the legal professional receives the legal disclosure form in a file type, or format that is easier to review and file.

In some embodiments, the system and method allows a client to securely and efficiently access a legal disclosure form that is editable and adapted to legal matters. The client, through the mobile communication device, populates the legal disclosure form with personal information, legal information, and at least one legally pertinent file. The client then securely transmits the populated legal disclosure form to a remote data storage unit through the same mobile communication device. At this stage, a legal professional has access to the remote data storage unit; and thereby the populated legal disclosure form.

The legal disclosure form creates a relationship with at least one aggregated form, such that the personal and legal information, and the legally pertinent files collected from the legal disclosure form are compiled into aggregate data. The aggregate data automatically populates the at least one aggregated form.

This compilation of information and legal files to aggregate data is possible because the method provides an algorithm that determines correspondence, association, and correlation between nodes of the two forms based on schemas of those forms. Thus, importing, merging, and annotating the information and legally pertinent file from the legal disclosure form into the filing form is based on correspondence, association, and correlation between the nodes. Finally, the legal professional receives the filing form in a format that can be easily reviewed and filed with a legal entity.

In one aspect, a method for collecting and automatically populating forms between a client and a legal professional, comprises:
providing, on a remote data storage unit, a legal disclosure form that is editable and adapted to legal matters;
downloading the legal disclosure form, by a client, on a mobile communication device;
populating the legal disclosure form directly through the mobile communication device with at least one of the following: personal information, legal information, and at least one legally pertinent file;
transmitting the populated legal disclosure form to the remote data storage unit; creating a relationship between the legal disclosure form and at least one aggregated form;
compiling the personal information, the legal information, and the at least one legally pertinent file into aggregate data;
transferring the aggregate data to the at least one aggregated form;
reviewing, by a legal professional, the at least one aggregated form; and filing, by the legal professional, the at least one aggregated form to a legal entity.

In another aspect, the method further comprises a step of logging in, by the client, to the remote data storage unit.

In another aspect, the method further comprises a step of selecting, by the client, a legal professional.

In another aspect, the method further comprises a step of selecting, by the client, a legal service to be performed by the legal professional.

In another aspect, the method further comprises a step of presenting the potential client with a retainer agreement, accessible via the mobile communication device of the potential client.

In another aspect, the method further comprises a step of the potential client accepting the retainer agreement and hiring the legal professional via the mobile communication device.

In another aspect, the method is operable with copyright law, trademark law, patent law; immigration law, and formation of corporations.

In another aspect, the method is operable with a software application on the mobile communication device.

In another aspect, the remote data storage unit is a server.

In another aspect, the legal disclosure form includes at least one of the following: an immigration application, a trademark application, and a patent application.

In another aspect, the legal disclosure form comprises at least one field, or at least one drop down box, or both.

In another aspect, the legal disclosure form comprises a spell check function.

In another aspect, the legal disclosure form comprises a location function.

In another aspect, the mobile communication device comprises at least one of the following: a smart phone, a tablet, and a digital personal assistant.

In another aspect, the personal information, the legal information, and the at least one legally pertinent file include at least one of the following: a copy of a driver's license, a copy of a birth certificate, a copy of a passport, an authorization form, a credit card number, a company logo, a laboratory record, a drawing, and a video.

In another aspect, the legal entity includes at least one of the following: a court house, a patent office, a trademark office, and a legal professional office.

In another aspect, the method further comprises a step of paying, by the client a fee, through the legal disclosure form.

In another aspect, the method further comprises a step of notifying the client, by the legal professional, additional requirements for the legal disclosure form.

One objective of the present invention is to streamline the collection and population of legal forms between a client and a legal professional.

Another objective is to provide a centralized server that stores and aggregates information from the client.

Another objective is to allow the client to populate and transmit a legal disclosure form through a mobile communication device, such as a smart phone.

Yet another objective is to enable the client to select the legal professional and the legal service through the mobile communication device.

Yet another objective is to aggregate the information and files provided by the client into a single aggregate file that is easily reviewed and filed to the legal entity.

Yet another objective is to create a uniform and clear form to file with a legal entity, such as a court house or a patent office.

Yet another objective is to provide typed entries into the legal forms, so that the information is easy to read.

Yet another objective is to format the form into a standard that the legal professional can file.

Yet another objective is to store the client information in a centralized server.

Yet another objective is to allow the legal professional to act on a particular matter without investing the time that is normally required to meet with, and bring in, new clients.

Yet another objective is to provide the client with the convenience associated with being able to hire a legal professional with minimal contact, making the idea of hiring a legal professional for certain matters, such as immigration law and intellectual property law, more desirable to potential clients that would otherwise not be interested in hiring a legal professional for that particular type of matter.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary method mobile mixing apparatus, in accordance with an embodiment of the present invention;

FIG. 2 illustrates a flowchart diagram of an exemplary method for collecting and automatically populating forms between a client and a legal professional in accordance with an embodiment of the present invention;

FIGS. 3A-3F illustrate separate pages of an exemplary LCA Form for H-1B immigration application, in accordance with an embodiment of the present invention;

FIG. 4 illustrates an exemplary Trademark Application form, in accordance with an embodiment of the present invention;

FIG. 5 illustrates an exemplary mobile communication device populating a legal disclosure form, in accordance with an embodiment of the present invention; and

FIG. 6 illustrates an exemplary legal disclosure form being automatically populated with personal information and legally pertinent information, in accordance with an embodiment of the present invention.

Like reference numerals refer to like parts throughout the various views of the drawings.

### DETAILED DESCRIPTION OF THE INVENTION

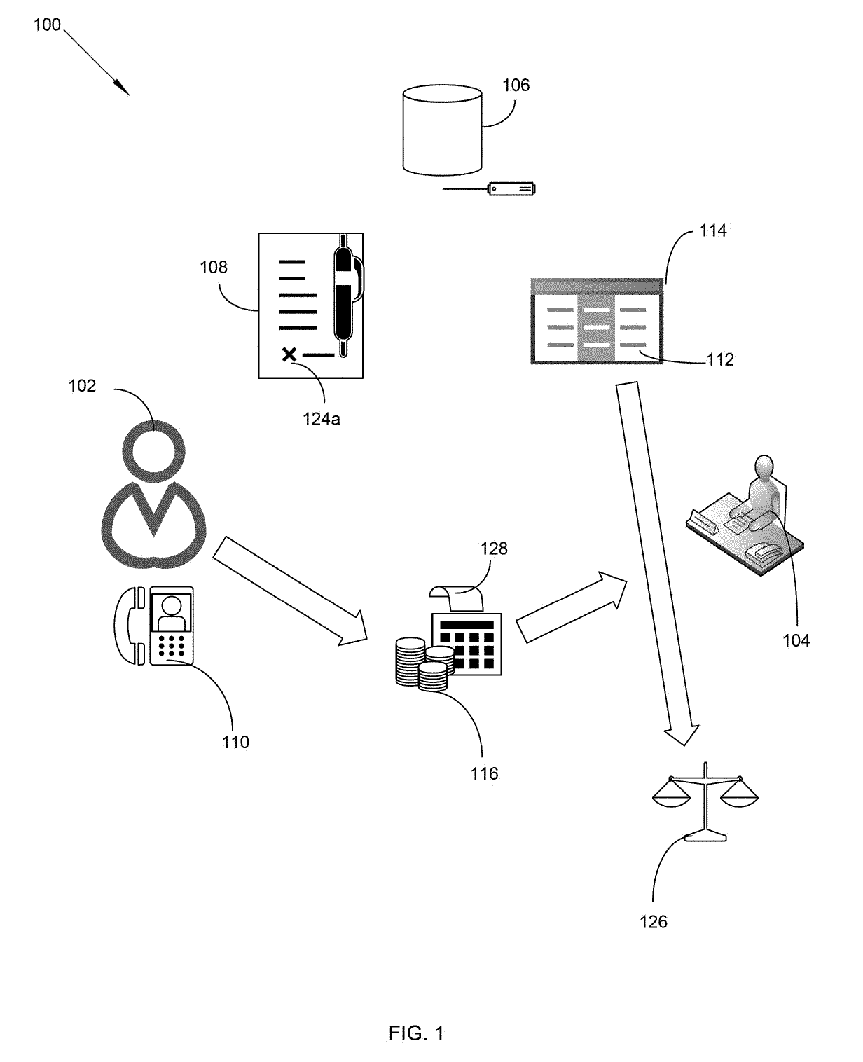

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A system 100 and method 200 for collecting and automatically populating forms between a client 102 and a legal professional 104 is referenced in FIGS. 1-6. The system 100 and method 200 for collecting and automatically populating legal forms between a client 102 and a legal professional 104, hereafter “system 100” and “method 200” enables a legal professional 104 to work efficiently with a potential client 102 while representing for a legal matter; and allows the client 102 to efficiently provide legally pertinent information to the legal professional 104 in a uniform format through use of a mobile communication device 110. This interactive relationship streamlines the communications between the client 102, the legal professional 104, and a legal entity 126 to which the forms are filed.

FIG. 1 references a diagram of an exemplary system 100 for collecting and automatically populating forms between a client 102 and a legal professional 104. The system 100 creates efficient interaction between a client 102 and a legal professional 104. The system 100 allows a potential client 102 to populate and transmit a legal disclosure form 108 through a mobile communication device 110. Thereafter, a legal professional 104 can access the legal disclosure form 108 for review and filing.

In some embodiments, the system 100 allows the client 102 to securely and efficiently access a legal disclosure form 108 that is editable and adapted to legal matters. The client 102, through a mobile communication device 110, populates the legal disclosure form 108 with personal information, legal information, and at least one legally pertinent file. The client 102 then securely transmits the populated legal disclosure form 108 to a remote data storage unit 106 through the same mobile communication device 110. At this stage, a legal professional 104 has access to the remote data storage unit 106; and thereby the populated legal disclosure form 108.

The system 100 provides an algorithm that matches the legal disclosure form 108 with an aggregated form 114, creating a relationship between the forms. The algorithm automatically populates the aggregated form 114 with the same information as the legal disclosure form 108, but in a format that is more easily reviewed and filed with a legal entity 126. In this manner, filling out the legal disclosure form 108 is easier for the client 102, and the legal professional 104 receives the legal disclosure form 108 in a file type, or format that is easier to review and file—that is as an aggregated form 114.

An algorithm creates a relationship between the legal disclosure form 108 and the at least one aggregated form 114, such that the personal and legal information, and the legally pertinent files collected from the legal disclosure form 108 are compiled into aggregate data 112. The aggregate data 112 is then automatically populated into the at least one aggregated form 114.

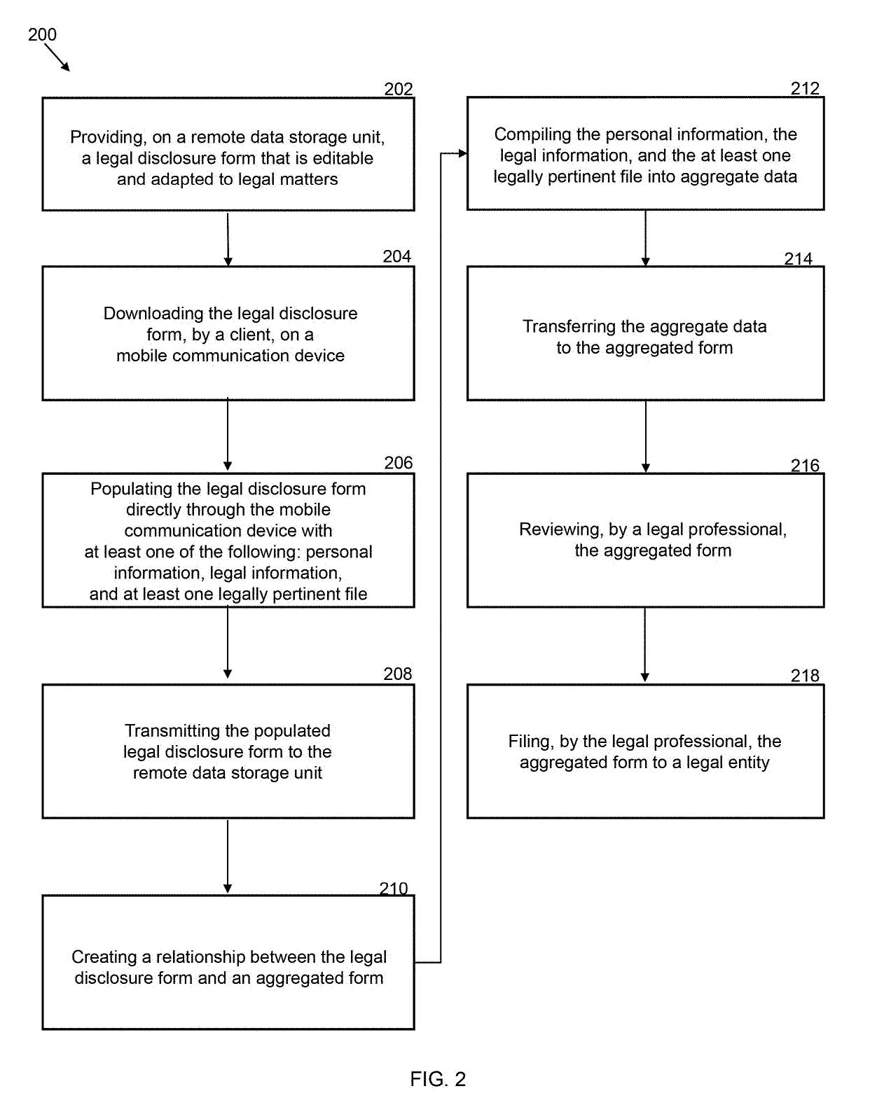

FIG. 2 illustrates a flowchart diagram of an exemplary method 200 for collecting and automatically populating forms between a client 102 and a legal professional 104. In some embodiments, the method 200 comprises an initial Step 202 of providing, on a remote data storage unit 106, a legal disclosure form 108 that is editable and adapted to legal matters. The legal disclosure form 108 is used to collect personal information, legal information, and at least one legally pertinent file. This information may include a name, a contact information, credit card information, work history, legal status, and family members.

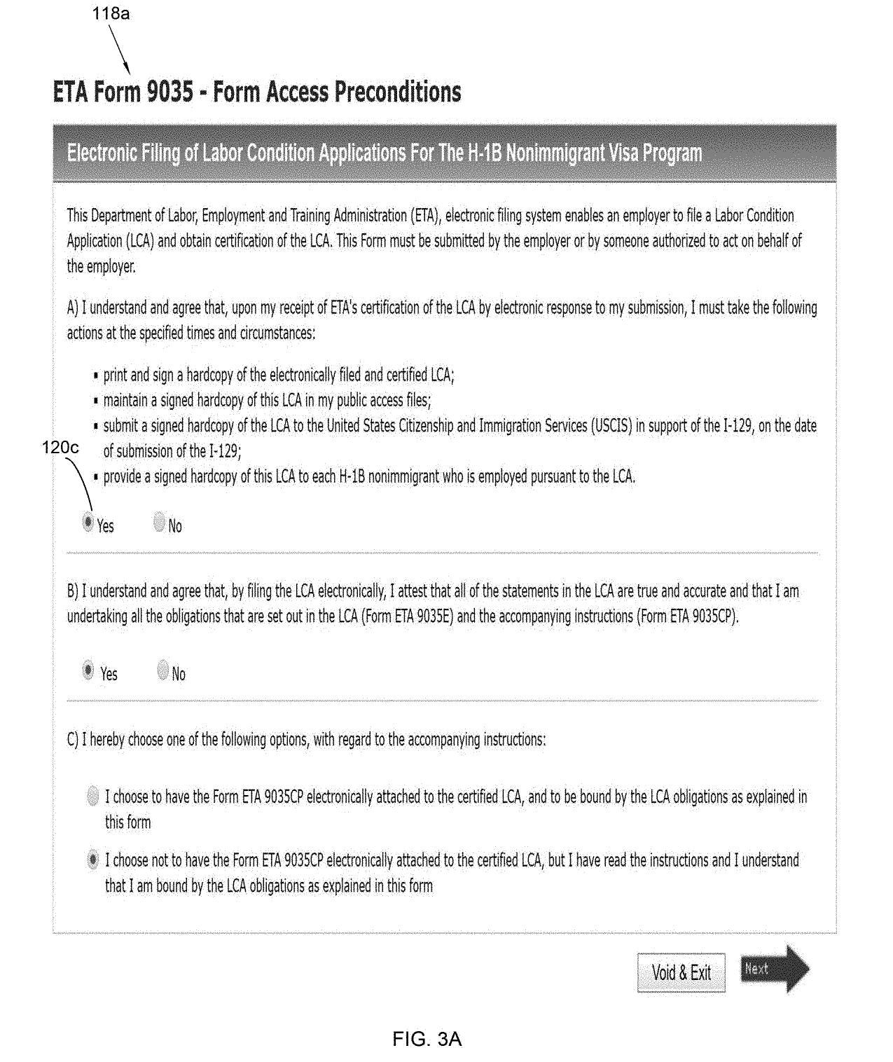

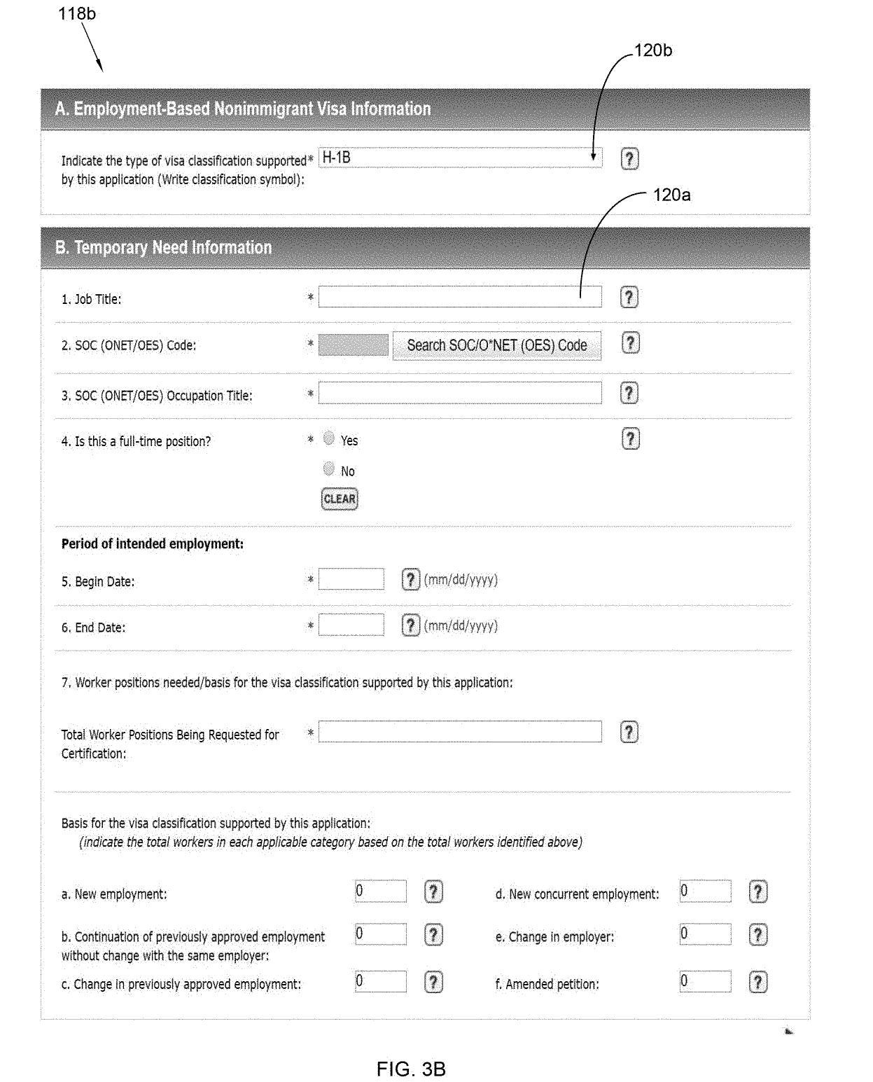

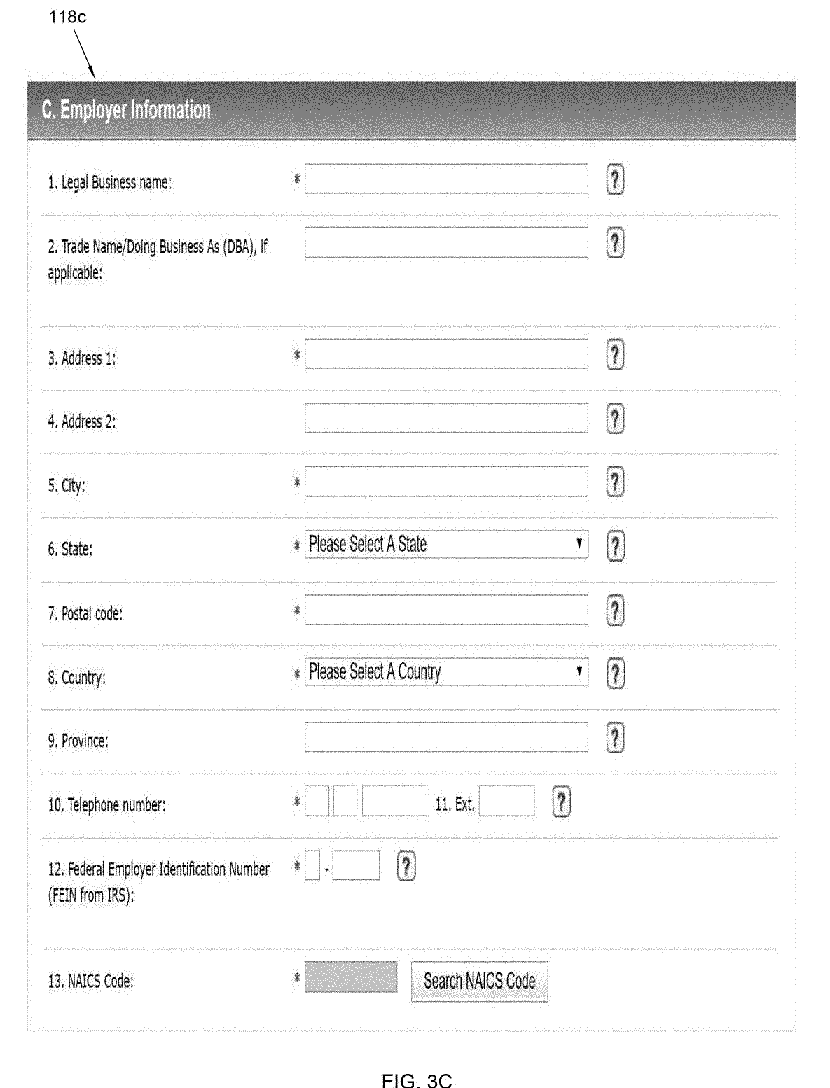

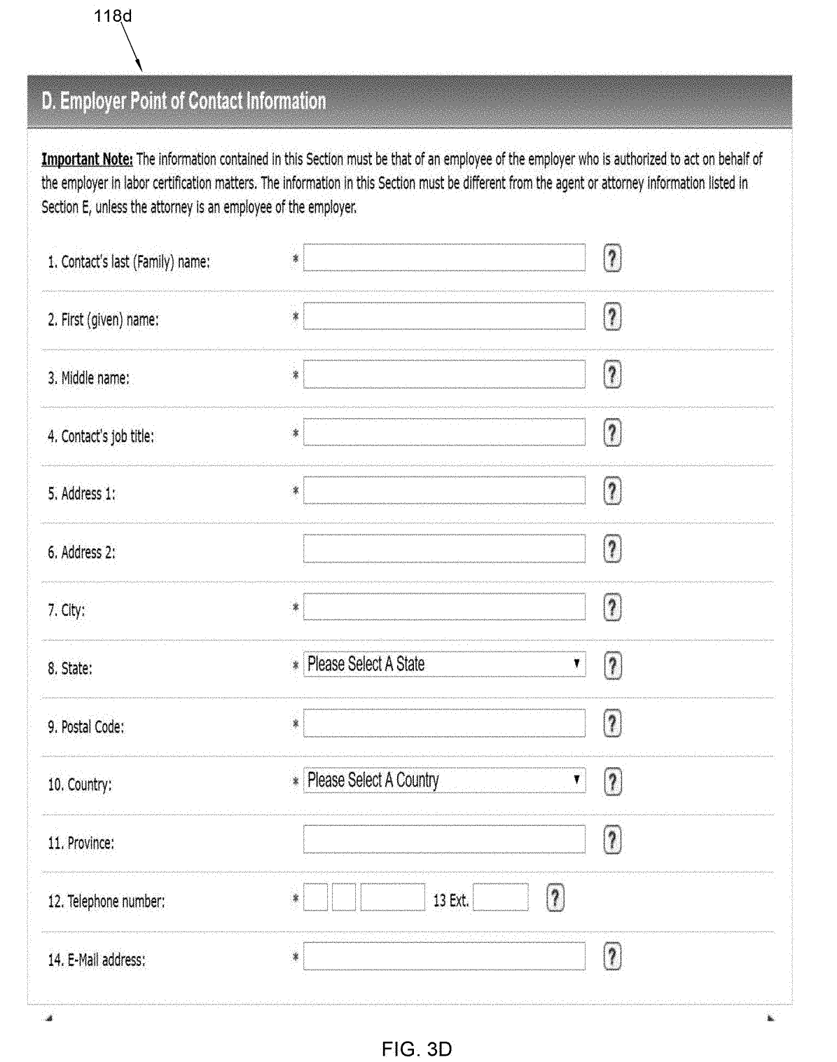

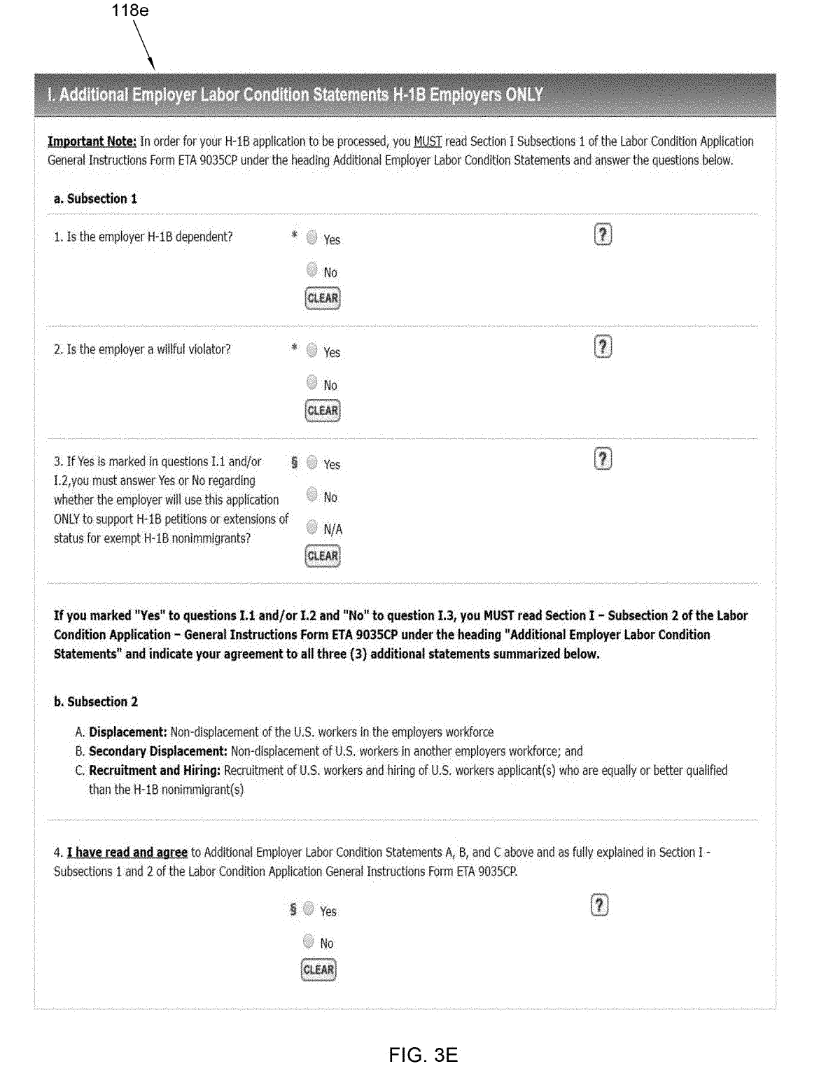

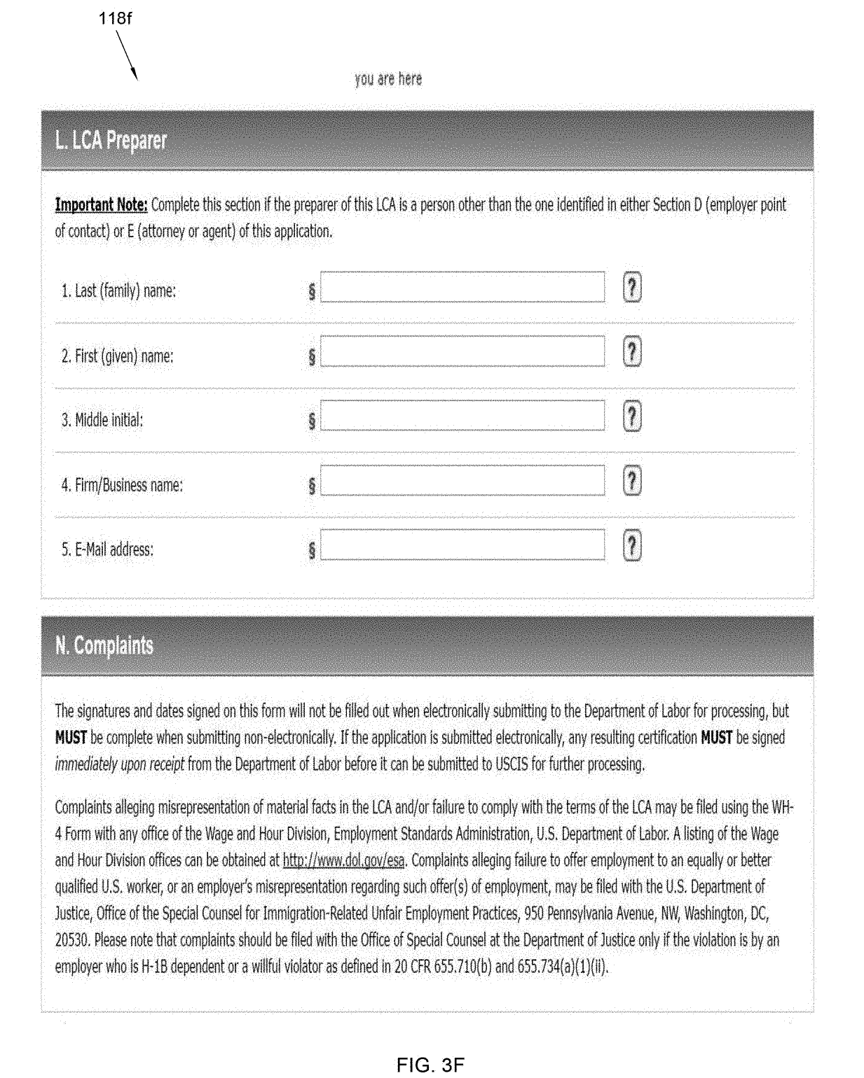

In one example of aggregated forms 114 shown in FIGS. 3A-3F, an ETA Form 9035 for H1B visa is an immigration application for a potential client 102 who is a non-immigrant in the United States and desires to obtain a visa. These forms 114 are not seen by the client, but only filed by the legal professional. However, the potential client 102 does use the legal disclosure form 108 to input information such as their name, contact information, family members, and the reason for requesting this particular work visa. Additional information pertinent to the work visa application may require the client 102 to upload a photo, a criminal background, and credentials for working in the field. It should be understood that other, additional information that may be relevant can be collected in a legal disclosure form of this example. All of this input information is aggregated for automatically filling out the aggregated forms 114 shown in FIGS. 3A-3F.

For example, FIG. 3A shows a first page 118a of the immigration application form providing selection buttons acknowledging requirements. FIG. 3B shows a second page 118b of the immigration application form providing a drop box with the desired visa options and employment information fields. FIG. 3C shows a third page 118c of the immigration application form providing fields for employer information. FIG. 3D shows a fourth page 118d of the immigration application form providing fields to fill in point of contact for employer.

Continuing, FIG. 3E shows a fifth page 118e of the immigration application form providing selection boxes for employment labor statements. And FIG. 3F shows a sixth page 118f of the immigration application form providing fields for the names of a different applier than the applicant, i.e., family member, legal professional 104, etc. In each page 118a-f, the requested information is pertinent to employment, since the HI B visa is a labor visa.

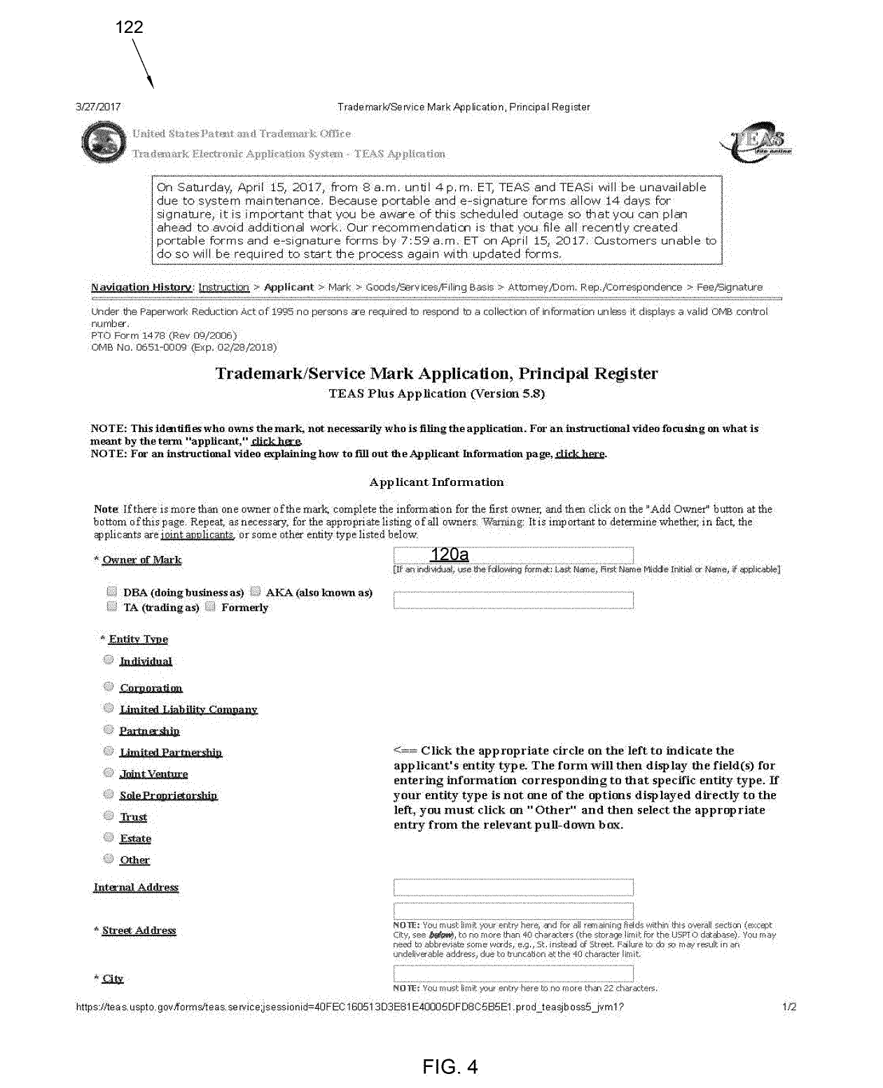

In one alternative embodiment shown in FIG. 4, the aggregated form 114 is a trademark application form 122 that is configured with the appropriate questions and fields to collect intellectual property information, such as a logo. This can be useful for copyrights, trademarks, and logos.

For example, the forms 114 can include a company logo intended for trademark; or a drawing of a mechanical apparatus intended for patenting; or a music video intended for copyrighting. The trademark application may require information such as: name, contact information, and a picture of the logo that the client 102 desires to trademark. Though alternative embodiments of intellectual property forms may also require inputting a laboratory note, a drawing, an image, and a video, such as for a patent application form.

In some embodiments, a step may include logging in, by the client 102, to the remote data storage unit 106. The logging in process may include the client 102 entering a username and a password. The method 200 is downloadable on the mobile communication device 110 through a software application “app”. Within the app, the client 102 is presented with an interface to input information relating to a particular legal matter.

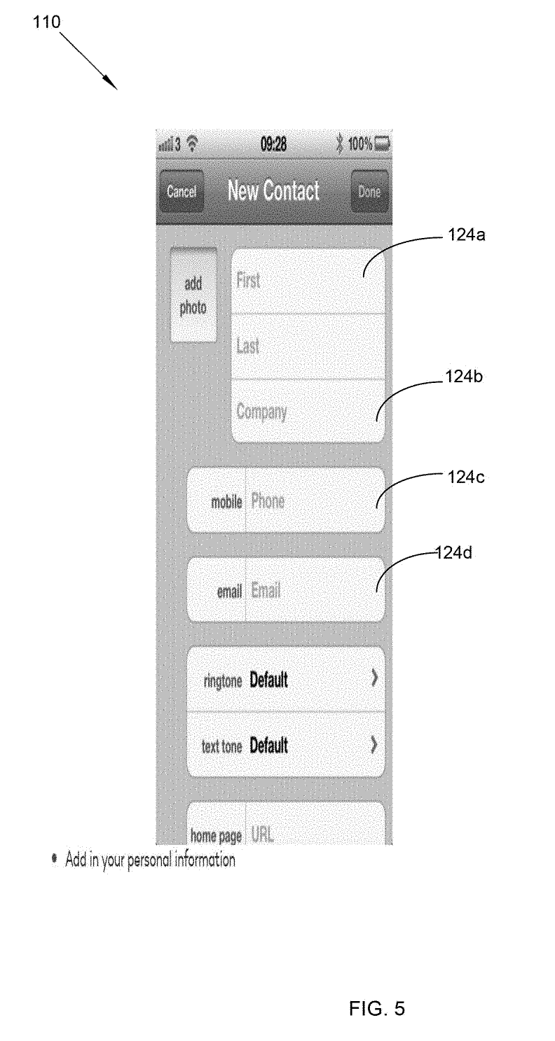

As FIG. 5 shows, a mobile communication device 110, such as a smart phone provides the necessary fields for logging in, logging out, performing video conferences, and performing any other functions necessary for collecting and automatically populating forms between client 102 and legal professional 104.

Thus, as FIG. 1 illustrates, the legal disclosure form 108 is populated by the client and the aggregated form 114 is be submitted to the relevant government entity. The client does not see or download aggregated form 114 shown in FIGS. 3A-F, 4, and 5 because these are screenshots of the actual forms that are submitted to the government entity. FIGS. 3A-F, 4, and 5 are simply examples of aggregated form 114, not legal disclosure form 108.

Another step of the method 200 comprises selecting, by the client 102, a legal professional 104 and a legal service to be performed by the legal professional 104. This selection is performed on the mobile communication device 110 at the convenience of the client 102. In one embodiment, the client 102 may select immigration legal assistance or intellectual property legal assistance. Though in other embodiments, any type of legal assistance may be requested by client 102. In some embodiments, the method 200 is operable with copyright law, trademark law, patent law; immigration law, and the formation of corporations and other legal organizations.

In some embodiments, potential clients 102 can hire the legal professional 104 using only a mobile communication device 110, such as a mobile phone. Other electronic devices are also contemplated, including, but not limited to, computers, tablets, or any other device capable of accessing the internet. The implementation of the method 200 according to the present disclosure involves a potential client 102 accessing application software (e.g., an “app” accessible via the internet, or in the form of an “app” downloaded onto a mobile phone) by way of an electronic device. Though in other embodiments, other forms of accessing the remote data storage unit 106 may be used.

A Step 204 may include downloading the legal disclosure form 108, by the client 102, on a mobile communication device 110. The client 102 may download the legal disclosure form 108 that matches the required legal assistance. For example, if the client 102 requires an HIB visa, the client 102 would download an immigration collection form created by legal professional 104, or the pertinent government agency. This legal professional supplied form may have similar forms to the form shown in FIG. 3A. Similarly, if the client 102 requires a trademark, the client 102 would download a trademark information form supplied by legal professional 104 or the pertinent government agency. This form is used to collect information about client and the trademark, and may be similar to a standard trademark application form (FIG. 4).

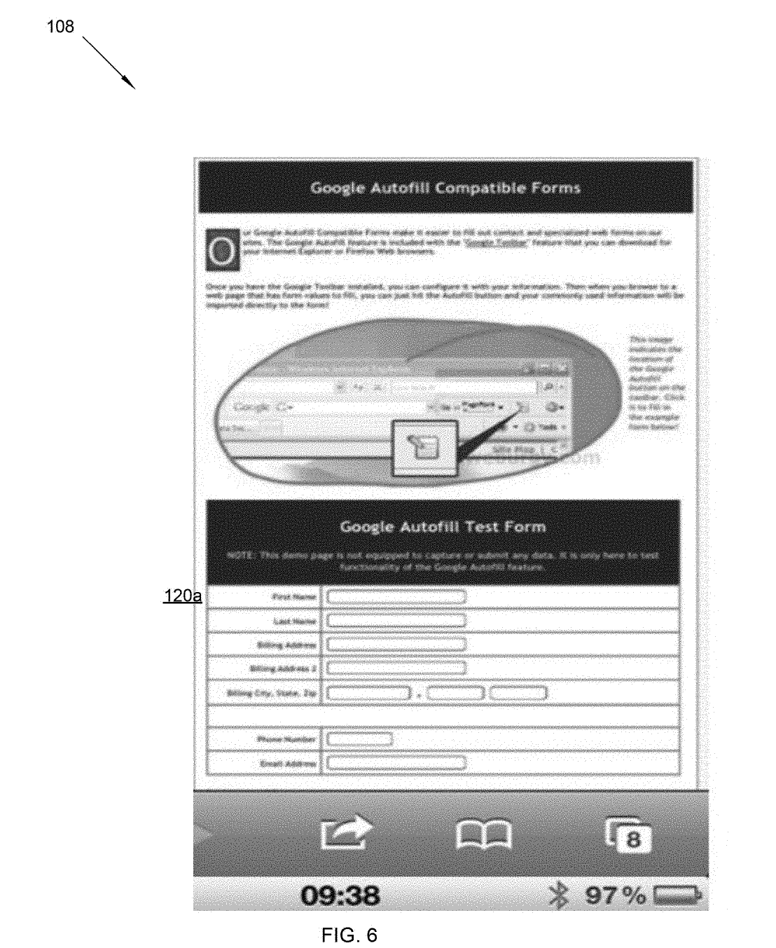

As illustrated in FIG. 6, a Step 206 may include populating the legal disclosure form 108 directly through the mobile communication device 110. Client 102 may populate the form 108 with at least one of the following: personal information, legal information, at least one legally pertinent file, a copy of a driver's license, a copy of a birth certificate, a copy of a passport, an authorization form, a credit card number, a company logo, a laboratory record, a drawing, and a video. In one embodiment, shown in FIG. 5, the information input to the legal disclosure form 108 includes a name 124a, a company 124b, a phone number 124c, and an email 124d.

Applicant may operate a keyboard on the mobile communication device 110 to type, speak, or upload this legally pertinent information. In this manner, the problem of poor handwriting is eliminated, as the legal disclosure form 108 is in a typed, digital format. The legal disclosure form 108 may provide at least one of the following input tools: at least one field 120a, at least one drop down box 120b, and at least one selection box 120c. These input tools are used by client 102 to populate the legal disclosure form 108. For example, FIG. 3A shows the client 102 selecting “Yes” on the selection box for the agreement to perform a series of actions upon filing.

In one embodiment, the legal disclosure form 108 includes at least one field 120a, at least one drop down box 120b, and at least one selection box 120c to fill in the necessary information. In another embodiment, the legal disclosure form 108 comprises a spell check function to ensure correct spelling by the client 102, and a location function to ensure the client 102 selects the correct address while populating the form.

A Step 208 includes transmitting the populated legal disclosure form 108 to the remote data storage unit 106. The transmission may include uploading the populated legal disclosure form 108 to the remote data storage unit 106. The remote data storage unit 106 may include, without limitation, a server, a database, a cloud, and a network.

It is significant to note that the method 200 allows for a file format that is accessible on the remote data storage unit and easy to aggregate the information thereon. In one embodiment, the legal disclosure form 108 comprises different types of file formats known in the art.

A Step 210 may include creating a relationship between the legal disclosure form 108 and at least one aggregated form 114. Those skilled in the art will recognize that the aggregated form 114 is simply an aggregate of the information. Thus, a relationship between the legal disclosure form 108 and the aggregated form 114 is required to enable transfer of the information from the legal disclosure form 108 to the aggregated form 114. The legal disclosure form is what the client receives to fill out. The aggregated form 114 is the form that compiles the data from the legal disclosure form 108. The aggregated form 114 is also the form that is actually filed in the appropriate entity.

In some embodiments, a Step 212 may include compiling the personal information, the legal information, and the at least one legally pertinent file into aggregate data 112. This aggregation is performed by the algorithm. Those skilled in the art will recognize that aggregations are a way of collapsing, summarizing, or grouping data. Thus, the information and legal files provided by the client 102 is aggregated to enable efficient transfer and create an easy to view form.

This compilation of information and files into aggregate data 112 is possible because the algorithm works to determine correspondence, association, and correlation between associated schemas of the two forms 108, 114. In one embodiment, the algorithm aggregates the information from the legal disclosure form 108 by interfacing with the forms, as if they were tables in a database. The algorithm may then utilize Boolean logic or fuzzy logic to aggregate the data from the tables.

For example, algorithm allows personal information to be aggregated; legally binding questions to be aggregated; logos and drawings to be aggregated; data selections from the drop box to be aggregated; etc. Thus, the aggregation is the compiling of the information supplied by the client 102 matched and combined into the appropriate fields in the aggregated form 114. Consequently, the legal professional 104 receives an aggregated form 114 that is in a format that can be easily reviewed and filed with a legal entity 126.

A Step 214 comprises transferring the aggregate data 112 to the aggregated form 114. This transfer of data is performed by the algorithm, generally by matching the schema for the legal disclosure form 108 and the aggregated form 114, and then transferring grouped information between matching schemas. For example, the algorithm groups the personal information from the legal disclosure form 108 and then transfers this grouped data to a matching schema on the aggregated form 114. This is repeated for logos, drawings, questions, etc.

However in other embodiments, the algorithm utilizes different means for transferring data. In one embodiment, the algorithm transfers the legally pertinent information from the populated legal disclosure form 108 through use of a data transfer object (DTO). The DTO is an object that carries the aggregated information (data) between processes. In other embodiments, the algorithm may use any means known in the art to transfer the information in the legal disclosure form 108 to the aggregated form 114.

Another Step 216 includes reviewing, by the legal professional 104, the aggregated form 114. While a smart phone is referenced in FIG. 5, the potential client 102 could use any other type of electronic device, such as a personal computer. Similarly, the legal professional 104 could use any other type electronic device, such as a mobile phone, tablet, or any other device capable of accessing the internet. The mobile communication device 110 of the client 102 is in communication with the remote data storage unit 106, which is in turn accessible by the legal professional 104, in this example, by way of a computer of the legal professional 104. In this manner, the legal professional 104 can review the information in an organized, aggregated setup having a preferred file format.

In some embodiments, the method 200 may include a step of notifying the client 102, by the legal professional 104, additional requirements for the legal disclosure form 108. This can be additional information or updates to past information that was provided by client 102.

Another alternative step may include of presenting the client 102 with a retainer agreement, accessible through the mobile communication device 110 of the potential client 102. Once the information is submitted, the potential client 102 is presented with a retainer agreement. The retainer agreement may explain the nature of the potential legal professional 104-client 102 relationship, includes information regarding a legal fee 116, and includes e-signatures of the potential client 102 and legal professional 104. This is all performed by the client 102 on the mobile communication device 110 and be the legal professional 104 on a similar communication device.

Another step comprises accepting, by the client 102, the retainer agreement 128 and hiring the legal professional 104 through the mobile communication device 110. The retainer agreement is capable of being accepted by the client 102 by way of the electronic device, in one example by the client 102 clicking an “accept” button provided in the interface of the electronic device. Client 102 may then perform the step of paying a fee 116 through the legal disclosure form 108. The payment is also possible through the mobile communication device 110. In some embodiments, the legal professional 104 may use credit card information and authorization supplied in the legal disclosure form 108 to charge the client 102.

A final Step 218 comprises filing, by the legal professional 104, the aggregated form 114 to a legal entity 126. In some embodiments, the legal entity 126 may include, without limitation, a court house, a patent office, a trademark office, and a legal professional office. The aggregated form 114 may include different file formats, legally pertinent information, drawings, videos, schematics, and the like that are determined by the type of legal issue being addressed, and the requirements of the legal entity 126.

For example, the US Patent and Trademark Office requires the filed forms to be in a pdf format that is optimized. Or a small claims court may require the filing fees to be in the form of a credit card or account number typed into the filed forms. Or an immigration court may require a photograph of the applicant in .jpg format. The aggregated form 114 allows for any of these variables. There are myriad form filing possibilities with the method 200.

Accordingly, using the above described method 200, a potential client 102 can directly hire a legal professional 104 using a mobile communication device 110, such as a mobile phone. On the one hand, the legal professional 104 can act on a particular matter without investing the time that is normally required to meet with, and bring in, new clients. On the other hand, the convenience associated with being able to hire a legal professional 104 with minimal contact makes the idea of hiring a legal professional 104 for certain matters, such as immigration law and intellectual property law, more desirable to the potential client 102 that would otherwise not be interested in hiring a legal professional 104 for that particular type of matter.

Yet another exemplary transaction of legal forms between client 102, legal professional 104, and government entity is described below. As described in method 200 above, the key to this application is the data management through the forms 108, 114. Initially, client 102 downloads a software application on the mobile communication device 110. In this embodiment, the first fields display for viewing by the client include a “Client Information Fill Out,” which contains fields such as name, address, business, phone number, etc.

Client 102 fills out these fields accordingly. Once client 102 fills legal disclosure form 108 out, that data is sent to remote data storage unit 106, such as a database, where a Client Object is created. The implementation of the data structure is determined by programmers once this is in production. The Client Object will be the access point for all relevant work orders for that particular client. It is significant to note that “Object” is used here in the sense of object oriented programming. Use of Objects allows for more efficient transfer of units of data. Though in other embodiments, other forms of data manipulation, storage, and display may be used, as known in technological arts.

At this stage of the method, the client 102 may submit a work order. For example, if client 102 wants to submit an LCA form. The LCA form is, in essence, the legal disclosure form 108. LCA form may require a client name (which is already stored, and therefore is not required again), job title, NAICS code, employer address, etc. The software application displays fields requesting this information when the client places the work order for the LCA form.

When client finishes filling out fields in LCA form, an LCA Form Object is created in the remote data storage unit 106 containing all the data for the LCA form, and the parent of this object is the Client Object. The client 102 then signs a retainer agreement through the software application.

At this point, the legal professional 104 reviews the completely filled out LCA form. Then software or algorithm retrieve all the data from the above mentioned Objects, autofill them on the government forms, as shown in FIGS. 3A-F, 4, and 5, and submits these aggregated forms 114 to the legal entity; thus completing the work order.

Further, there may also be instances where client 102 wishes to submit a second LCA form, but for a different job title. Since all the relevant information has been collected in the previous work order, the client is only required to provide the new job title. This second work order is completed with a single interaction with the client 102, and a single item typed into the appropriate field. Any subsequent LCA forms are also filed in this expedited manner. In any case, the essence of the present system 100 and method 200 is the management and efficient manipulation of data in legal forms.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. One or more computer storage media storing computer-usable instructions, that when used by one or more computing devices, cause the one or more computing devices to perform a method for collecting and automatically populating forms between a client and a legal professional, the method comprising:
providing, on a remote data storage unit, a legal disclosure form that is editable and adapted to legal matters;
downloading the legal disclosure form, by a client, on a mobile communication device;
populating the legal disclosure form directly through the mobile communication device with at least one of the following: personal information, legal information, and at least one legally pertinent file;
transmitting the populated legal disclosure form to the remote data storage unit;
creating a relationship between the legal disclosure form and at least one aggregated form;
compiling the personal information, the legal information, and the at least one legally pertinent file into aggregate data;
transferring the aggregate data to the at least one aggregated form;
reviewing, by a legal professional, the at least one aggregated form; and
filing, by the legal professional, the at least one aggregated form to a legal entity.

2. The method of claim 1, further comprising a step of logging in, by the client, to the remote data storage unit.

3. The method of claim 1, further comprising a step of selecting, by the client, the legal professional and a legal service to be performed by the legal professional.

4. The method of claim 1, further comprising a step of paying, by the client, a fee through the legal disclosure form.

5. The method of claim 1, further comprising a step of notifying the client, by the legal professional, additional requirements for the legal disclosure form.

6. The method of claim 1, further comprising a step of presenting the client with a retainer agreement, accessible through the mobile communication device of the potential client.

7. The method of claim 6, further comprising a step of accepting, by the client, the retainer agreement and hiring the legal professional through the mobile communication device.

8. The method of claim 1, wherein the method is operable with copyright law, trademark law, patent law; immigration law, and formation of corporations.

9. The method of claim 1, wherein the method is operable with a software application on the mobile communication device.

10. The method of claim 1, wherein the remote data storage unit is a server.

11. The method of claim 1, wherein the legal disclosure form includes at least one of the following: an immigration application, a trademark application, and a patent application.

12. The method of claim 1, wherein the legal disclosure form includes at least one of the following: at least one field, at least one drop down box, and at least one selection box.

13. The method of claim 1, wherein the legal disclosure form comprises a spell check function and a location finder function.

14. The method of claim 1, wherein the mobile communication device comprises at least one of the following: a smart phone, a tablet, and a digital personal assistant.

15. The method of claim 1, wherein the personal information, the legal information, and the at least one legally pertinent file include at least one of the following: a copy of a driver's license, a copy of a birth certificate, a copy of a passport, an authorization form, a credit card number, a company logo, a laboratory record, a drawing, and a video.

16. The method of claim 1, wherein the legal entity includes at least one of the following: a court house, a patent office, a trademark office, and a legal professional office.

17. One or more computer storage media storing computer-usable instructions, that when used by one or more computing devices, cause the one or more computing devices to perform a method for collecting and automatically populating forms between a client and a legal professional, the method comprising:
providing, on a remote data storage unit, an intellectual property legal disclosure form that is editable and adapted to intellectual property legal matters;
downloading the intellectual property legal disclosure form, by a client, on a mobile communication device;
populating the intellectual property legal disclosure form directly through the mobile communication device with at least one of the following: personal information, legal information, at least one legally pertinent file, a logo, a laboratory note, a drawing, an image, and a video;
transmitting the populated intellectual property legal disclosure form to the remote data storage unit;
creating a relationship between the intellectual property legal disclosure form and at least one aggregated form;
creating a relationship between the intellectual property legal disclosure form and a patent application, or a trademark application, or both;
creating a relationship between the legal disclosure form and a drawing form;
compiling the personal information, the legal information, the at least one legally pertinent file, the logo, the laboratory note, the drawing, the image, and the video into aggregate data;
transferring the aggregate data to the at least one aggregated form, the patent application, trademark application, and the drawing form;
reviewing, by a legal professional, the at least one aggregated form, the patent application, the trademark application, and the drawing form; and
filing, by the legal professional, the at least one aggregated form, the patent application, trademark application, and the drawing form to a legal entity.

18. The method of claim 17, wherein the mobile communication device comprises at least one of the following: a smart phone, a tablet, and a digital personal assistant.

19. The method of claim 17, wherein the personal information, the legal information, and the at least one legally pertinent file include at least one of the following: a copy of a driver's license, a copy of a birth certificate, a copy of a passport, an authorization form, a credit card number, a company logo, a laboratory record, a drawing, and a video.

20. A system for collecting and automatically populating forms between a client and a legal professional, the system comprising:
a remote data storage unit configured to store a legal disclosure form;
a client having a mobile communication device configured to access and populate the legal disclosure form,
the algorithm further configured to enable the client to populate the legal disclosure form directly through the mobile communication device with at least one of the following: personal information, legal information, and at least one legally pertinent file;
an algorithm configured to create a relationship between the legal disclosure form and at least one aggregated form, the algorithm further configured to compile the personal information, the legal information, and the at least one legally pertinent file into aggregate data that populates the at least one aggregated form; and
a legal professional filing the populated aggregated form with a legal entity.
